(19) United States
(12) Patent Application Publication
(10) Pub. No.: US 2010/0018367 A1
(43) Pub. Date: Jan. 28, 2010

(54) TORQUE WRENCH

(76) Inventor: Jun-Tsai Shyu, Taichung (TW)

Correspondence Address: Guice Patents PLLC, 12647 Galveston Court #302, Manassas, VA, 20112, US

(21) Appl. No.: 12/181,318

(22) Filed: Jul. 28, 2008

(51) Int. Cl. B25B 23/14

(52) U.S. Cl. 81/467

(57) ABSTRACT

A torque wrench having a force-acting rod with a handle portion as well as a driving head assembly. The driving head assembly includes an action portion having a polygonal insertion portion in cooperation with a unidirectional ratchet mechanism. In this way, a screw element can be directly tightened or loosened by means of the polygonal insertion portion.

### BACKGROUND OF THE INVENTION

1. Fields of the Invention

The invention relates to a torque wrench, and more particularly, to a structure that ensures a direct tightening or loosening of a screw element without mounting accessories such as sockets or angular adapters.

2. Description of the Related Art

The so-called torque wrench is a special wrench with a prearranged torque value for tightening screw elements with a fixed torque. Representative torque wrenches are shown in FIGS. 4 and 5. As shown in FIG. 4, the torque wrench includes a force-acting rod 11 with a torque-adjusting portion 10 as well as a driving head assembly 12. The driving head assembly 12 includes an action portion 13 having a polygonal insertion lug 14 that is longitudinally extended and works in cooperation with a unidirectional ratchet mechanism (not shown). The operation requires a socket (not shown) that is mounted on the insertion lug 14. The socket includes a polygonal action portion at the other end thereof for tightening or loosening the screw elements.

FIG. 5 shows another conventional construction having a force-acting rod 21 with a torque-adjusting portion 20 and a mounting assembly 22. The mounting assembly 22 has an action end 23 with a polygonal recess 24 coaxially arranged relative to the force-acting rod 21. Therefore, the operation requires an angular adapter (not shown) fitting into the polygonal recess 24 in a vertical force-acting position. Thus, the screw element (not shown) can be tightened or loosened by the polygonal action portion at the other end of the angular adapter.

In other words, the above-mentioned constructions require an additional socket or angular adapter to tighten or loosen the screw element. Thus, the operation is more complicated. Even, the conventional torque wrenches cannot be used just because the necessary accessories are not present or defected.

### SUMMARY OF THE INVENTION

In view of the shortcomings of the prior art, the inventor of the present invention, based on years of experience in the related industry to conduct extensive researches and experiments, finally developed a torque wrench eliminating all of the drawbacks in operation and production of the conventional products and the prior structures. Meanwhile, the convenience and the practicalness of the invention are ensured. This is the primary object of the invention.

A first object of the invention is to provide an assembly element of a hand tool and to change the form and the structure of the largest part of the assembly element such that the above-mentioned drawbacks of the conventional products can be eliminated while the convenience and the practicalness of the invention are ensured.

A second object of the invention is to provide an assembly element of a hand tool that includes more than one annular groove formed in the largest portion thereof as an identification label for an easy identification of the item number, size, type, etc.

According to the invention, a driving head assembly includes an action portion having a polygonal insertion portion in cooperation with a unidirectional ratchet mechanism. In this way, a screw element can be directly tightened or loosened by means of the polygonal insertion portion.

### BRIEF DESCRIPTION OF THE DRAWINGS

The accomplishment of this and other objects of the invention will become apparent from the following description and its accompanying drawings of which:

FIG. 1 is a perspective view of a first embodiment of the invention;

FIG. 2 is a perspective view of a second embodiment of the invention;

FIG. 3 is a perspective view of a third embodiment of the invention;

FIG. 4 is a perspective view of a conventional torque wrench; and

FIG. 5 is a perspective view of another conventional torque wrench.

### DETAILED DESCRIPTION OF THE PREFERRED EMBODIMENT

The present invention will now be described in more detail hereinafter with reference to the accompanying drawings that show various embodiments of the invention.

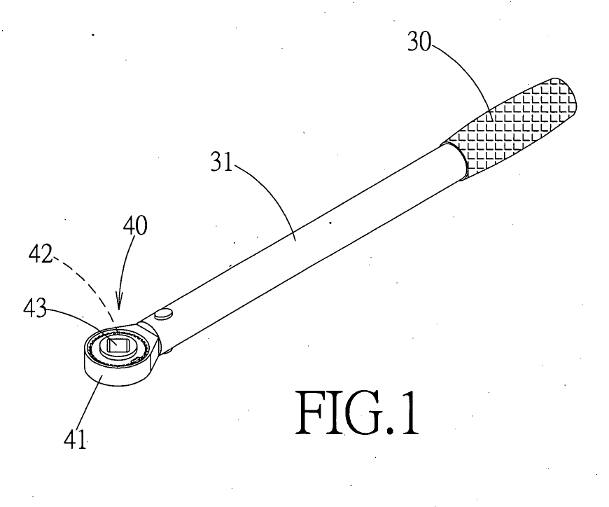

Referring to FIG. 1, a torque wrench in accordance with a preferred embodiment of the invention includes a force-acting rod 30 with a handle portion 31 as well as a driving head assembly 40. The driving head assembly 40 includes an action portion 41 having a polygonal insertion portion 43 in cooperation with a unidirectional ratchet mechanism 42. In this way, a screw element (not shown) can be directly tightened or loosened by means of the polygonal insertion portion 43.

A torque-adjusting mechanism is installed within a hollow internal hole of the handle portion 31. This mechanism has been disclosed in the prior art so that no further descriptions thereto are given hereinafter.

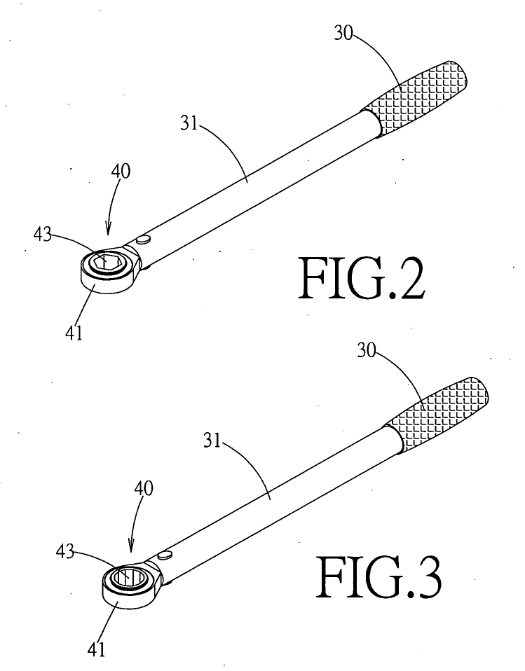

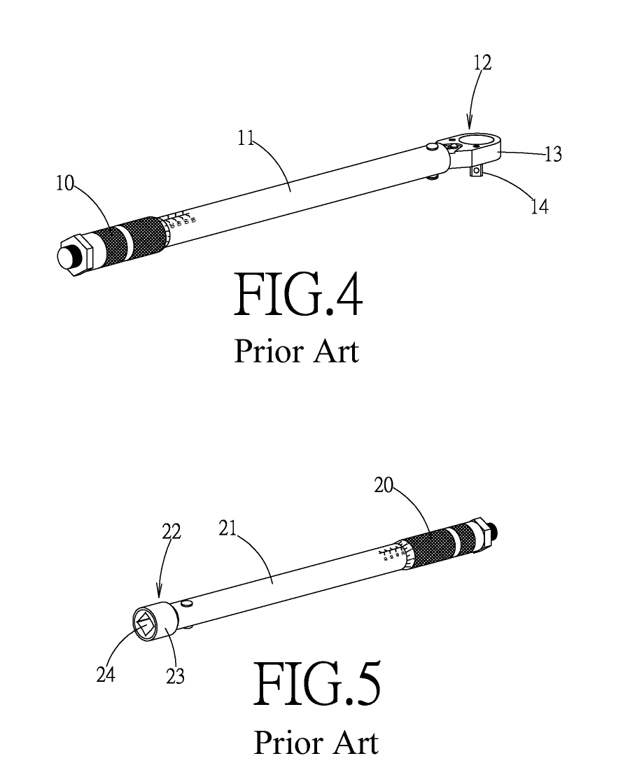

Referring to FIGS. 2 and 3, the insertion portion 43 includes an internal hole having different types and sizes such as in a quadrangular, a hexagonal or a plum shape, thereby meeting different use requirements.

When the screw element is tightened or loosened by the torque wrench of the invention in a vertical position, a direct force-acting effect is achieved in addition to the convenience without attaching accessories thereto. Moreover, an undesired slip of the accessories won't take place in acting force thereon. Therefore, an excellent use safety is ensured.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1. A torque wrench comprising:
a force-acting rod having a handle portion, and a driving head assembly,
wherein the driving head assembly includes an action portion having a polygonal insertion portion in cooperation with a unidirectional ratchet mechanism, and
wherein the insertion portion is perpendicular to the axis of the force-acting rod,
wherein the polygonal insertion assembly has a cross section having at least four straight line segments.

2. The torque wrench as recited in claim 1, wherein the cross section of the polygonal insertion assembly is a quadrilateral.

3. The torque wrench as recited in claim 1, wherein the cross section of the polygonal insertion assembly is a hexagonal.
